(19) United States
(12) Patent Application Publication
(10) Pub. No.: US 2007/0169480 A1
(43) Pub. Date: Jul. 26, 2007

(54) Power generating machine

(76) Inventor: Chin-Ho Chiu, Sansia Township (TW)

Correspondence Address: TROXELL LAW OFFICE PLLC, 5205 LEESBURG PIKE, SUITE 1404, FALLS CHURCH, VA, 22041, US

(21) Appl. No.: 11/491,256

(22) Filed: Jul. 24, 2006

(30) Foreign Application Priority Data
Jan. 25, 2006 (TW) 095201668

(51) Int. Cl. F02G 3/00; A63H 29/08

(52) U.S. Cl. 60/614; 446/173

(57) ABSTRACT

A power generating machine, including a frame with a stand thereon, two racks, two carriages, two branches and two spaced rods wherein horizontal tracks are at two sides of the frame bottom and the racks are at two sides of the stand and an inner post of the rack has a top guide wheel. The two carriages are connected movably at their inner sides with the two racks and have bottom tracks over the corresponding horizontal ones of the frame wherein an elastic member is disposed and moves within the bottom tracks. The two branches are linked at sides of the stand and connected with the carriages by a linking member, and two spaced rods are linked at sides of a crossbar so that when elastic member moves, the moment of force is changed, and the stand will sway if the linking member is pressed.

### FIELD OF THE INVENTION

The present invention relates to a power generating machine and, more particularly, to a power generating machine in which a bar can be swayed on a central fulcrum without inputting energy, and is applicable to various power equipments as the power supply.

### BACKGROUND OF THE INVENTION

In recent years more and more energy resources, such as wind power, solar energy, waterpower, geothermal heat and the like, are put into use for generating electricity due to the nearly exhausted energy on the Earth.

However, not all of these energy resources can be utilized everywhere. For example, it is not advisable to utilize wind power in an area where the wind is weak all the year round, or to utilize solar energy in an area where is always rainy. Waterpower and geothermal heat can be utilized only in an area where such natural resources exist.

### SUMMARY OF THE INVENTION

It is an objective of the present invention to provide a power generating machine which can generate power without inputting energy.

To achieve the aforementioned objectives, the present invention provides a power generating machine including a frame formed with a stand and a pair of substantially horizontal tracks at sides of the stand. A bar is balanced on a central fulcrum situated on the stand and has a pair of upwardly extending branches formed at sides of the central fulcrum. A pair of H-shaped racks is arranged symmetrically on the bar with each rack having an inner post and an outer post, and the inner post has a top guide wheel pivoted thereon. A pair of carriages is pivotally connected at inner sides thereof with the racks. Each of the carriages has a bottom track over corresponding one of the substantially horizontal tracks, and an elastic member stretched substantially vertically between the bottom track and corresponding one of the substantially horizontal tracks. The carriages are provided with respective long, flexible linking members stretched between the carriages and the branches. A pair of spaced rods extends upward from the stand and has respective top guide wheels pivoted thereon. Furthermore, the guide wheels on the rods, together with the guide wheels on the inner posts of the H-shaped racks, are capable of pressing the long, flexible linking members so as to control the carriages in such a way that the bottom tracks are always kept substantially horizontal when the bar is in any angular position relative to the stand. Therefore, the bar sways when the elastic members are moved along the tracks.

Other objectives, advantages and novel features of this invention will become more apparent from the following detailed description when taken in conjunction with the accompanying drawings.

### BRIEF DESCRIPTION OF THE DRAWINGS

FIG. 1 is a schematic view of a power generating machine in accordance with the present invention, with a carriage in its highest position;

FIG. 2 is a schematic view of the power generating machine in FIG. 1, showing a pair of elastic members moving in a rightward direction;

FIG. 3 is a schematic view of the power generating machine in FIG. 1, with another carriage in its highest position; and

FIG. 4 is a schematic view of the power generating machine in FIG. 1, showing a pair of the elastic members moving in a leftward direction.

### DETAILED DESCRIPTION OF THE PREFERRED EMBODIMENT

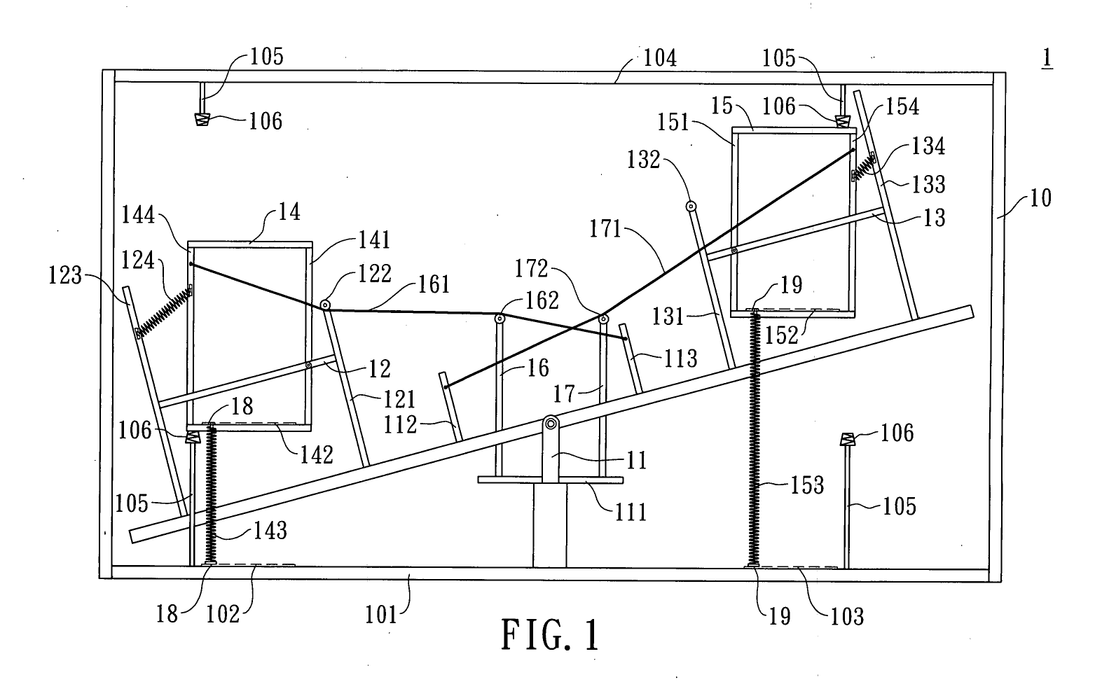

Referring to FIG. 1, there is shown a preferred embodiment of a power generating machine 1 in accordance with the present invention. The power generating machine 1 includes a frame 10 having a bottom crosspiece 101 and a top crosspiece 104, wherein the crosspieces 101 and 104 are formed with respective stems 105 and each stem preferably ends in a damping spring 106.

The frame 10 is further formed with a stand 11 and a pair of substantially horizontal tracks 102 and 103 at sides of the stand 11. A bar (not numbered) is balanced on a central fulcrum situated on the stand 11. The bar has a pair of upwardly extending branches 112,113 formed at sides of the central fulcrum.

Arranged symmetrically on the bar at sides of the central fulcrum is a pair of H-shaped racks 12 and 13 each having an inner post 121 or 131 and an outer post 123 or 133, and the inner post 121 or 131 has a top guide wheel 122 or 132 pivoted thereon.

A pair of carriages 14 and 15 is pivotally connected at inner sides 141 and 151 thereof with the racks 12 and 13, respectively. As clearly shown, each of the carriages 14 and 15 has a bottom track 142 or 152 over corresponding one of the substantially horizontal tracks 102 and 103, and an elastic member 143 or 153, such as a tension spring, stretched substantially vertically between the bottom track 142 or 152 and the substantially horizontal track 102 or 103. Preferably, the carriages 14 and 15 have respective outer sides 144 and 154 opposite to the inner sides 141 and 151, and each of the carriages 14 or 15 is provided with a second elastic member 124 or 134, such as a second tension spring, stretched between the outer side 144 or 154 thereof and the outer post 123 or 133 of the H-shaped rack 12 or 13.

The carriages 14 and 15 are further provided with respective long, flexible linking members 161 and 171, such as cords, chains, and the like, which are stretched between the carriages 14 and 15 and the branches 112 and 113, preferably between the outer sides 144 and 154 of the carriages 14 and 15 and the branches 112 and 113. These linking members 161 and 171 are stretched tightly by the action of the elastic members 143, 153, 124 and 134 exerted upon the carriages 14 and 15.

Furthermore, a pair of spaced rods 16 and 17 extends upward from a crossbar 111 of the stand 11 and has respective top guide wheels 162 and 172 pivoted thereon. The guide wheels 162 and 172 on the rods 16 and 17, together with the guide wheels 122 and 132 on the inner posts 121 and 131 of the H-shaped racks 12 and 13, are capable of pressing the long, flexible linking members 161 and 171 so as to control the carriages 14 and 15 in such a way that the bottom tracks 142 and 152 are always kept substantially horizontal when the bar is in any angular position relative to the stand 11.

In such a configuration, the bar can be swayed about the central fulcrum with the carriages 14 and 15 each moving up and down between a highest position, in which the carriage 14 or 15 is stopped by one of the stems 105 on the top crosspiece 104, and a lowest position, in which the carriage 14 or 15 is stopped by one of the stems 105 on the bottom crosspiece 101.

As clearly shown, each carriage 14 or 15 is further equipped with an actuator 18 or 19, such as a motor, for moving the elastic member 143 or 153 to and fro along the tracks 102 and 142, or 103 and 152.

Referring still to FIG. 1, the inventive machine can be started by lowering the left end of the lever until the carriage 14 is moved to the lowest position and the carriage 15 is moved to the highest position, and by moving the elastic members 143 and 153 to the left ends of the tracks 142 and 152.

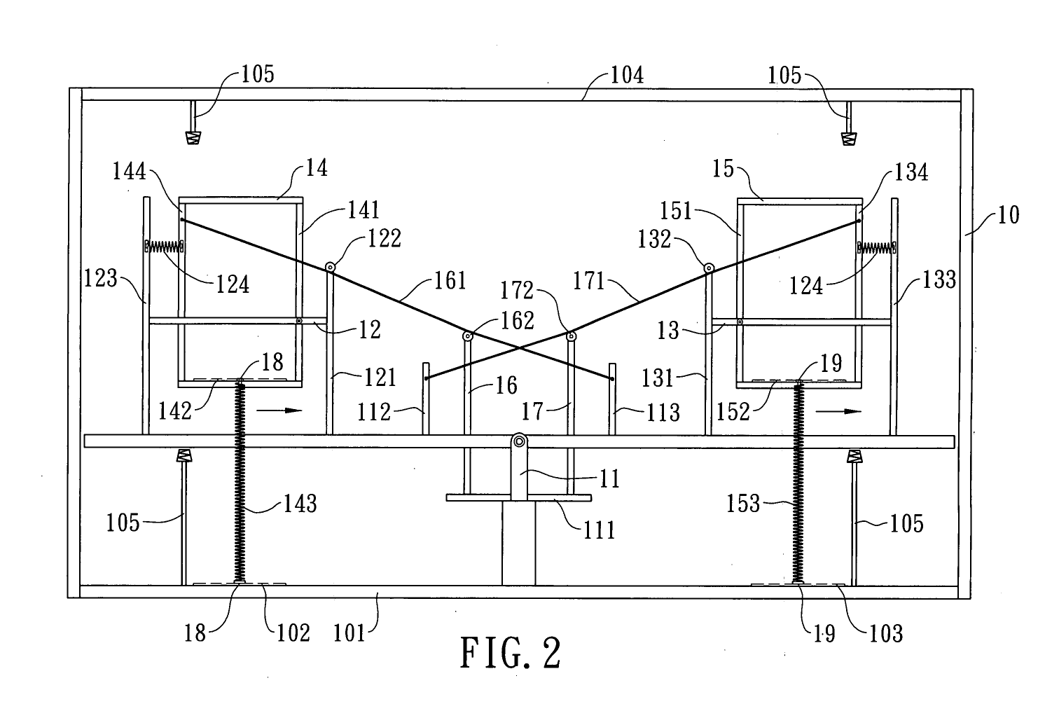

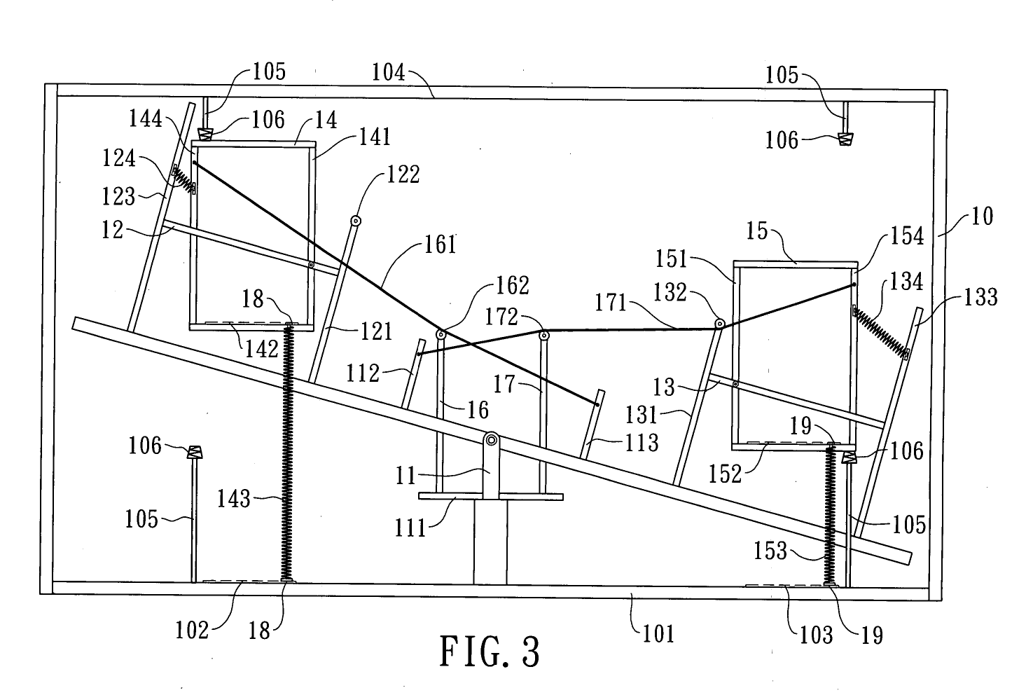

Referring to FIGS. 1 to 2, as the elastic members 143 and 153 are moved along the substantially horizontal tracks 102,142,103 and 152 by the actuators 18 and 19 in a rightward direction, as designated by arrows in FIG. 2, the perpendicular distance of the tension force of the elastic member 143 from the central fulcrum and hence the moment of the tension force of the elastic member 143 about the central fulcrum is gradually decreased. During the meantime, however, the perpendicular distance of the tension force of the elastic member 153 from the central fulcrum and hence the moment of the tension force of the elastic member 153 about the central fulcrum is gradually increased. The change of the moments turns the bar in a clockwise direction from the position as shown in FIG. 1 to the position as shown in FIG. 3, making the carriage 14 to be moved to its highest position and the carriage 15 to be moved to its lowest position.

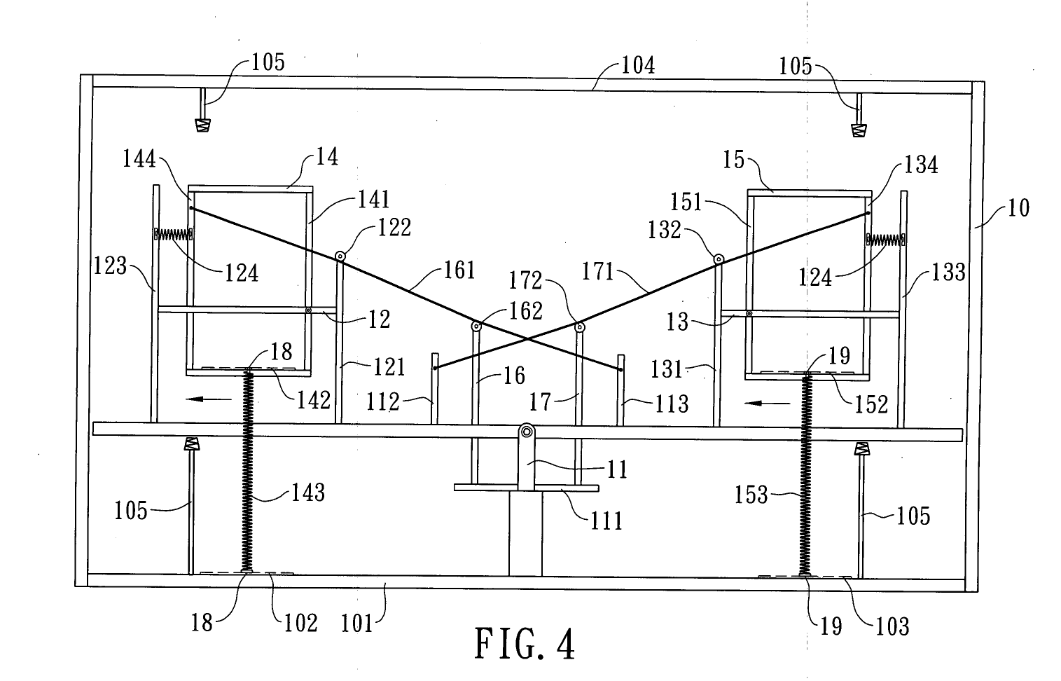

As soon as the carriages 14 and 15 reach their extreme positions, the elastic members 143 and 153 are moved again, by the actuators 18 and 19, along the substantially horizontal tracks 102, 142, 103 and 152 in a leftward direction, as designated by the arrows in FIG. 4. The movement of the elastic member 143 and 153 now turns the bar in a counter-clockwise direction from the position as shown in FIG. 3 to the position as shown in FIG. 1, making the carriage 14 to be moved to its lowest position and the carriage 15 to be moved to its highest position. The repeated turning of the bar alternately in the clockwise and counter-clockwise directions makes up the swaying of the bar.

During the swaying, the horizontal disposition of the tracks 102, 142, 103 and 152 and the vertical disposition of the elastic members 143 and 153 enable the actuators 18 and 19 to move the elastic members 143 and 153 with a horizontal force in a magnitude as small as the friction between ends of the elastic members 143 and 153 and the tracks 102, 142, 103 and 152, which, as well-known, can be greatly reduced by lubrication. In other words, the actuators 18 and 19 can move the elastic members 143 and 153 without doing work if the friction is omitted.

In the present invention, the guide wheels 122, 162, 132 and 172 can be optionally arranged so that when either one of the carriages 14 and 15 is moved to its highest position, the long, flexible linking member 161 or 171 connected to the carriage 14 or 15 in the highest position may be disengaged from the guide wheel 122 or 132 on the inner post 121 or 131, as shown in FIGS. 1 and 3 respectively, or, alternatively, may be disengaged from the guide wheels 122 and 162 or 132 and 172 both on the inner post 121 or 131 and on the rod 16 or 17.

From the foregoing, it is apparent that the reciprocated movement of the elastic members 143 and 153 along the tracks 102, 142, 103 and 152 will sway the bar and thereby will produce energy.

Although the embodiment and its structures and functions of the present invention have been described in detail, many modifications and variations may be made from the teachings disclosed above. Therefore, it should be understood by those skilled in the art that any modification and variation equivalent to the spirit of the present invention should be regarded to fall into the scope defined by the appended claims.

What is claimed is:

1. A power generating machine, comprising:
a frame formed with a stand and a pair of substantially horizontal tracks at sides of said stand;
a bar balanced on a central fulcrum situated on said stand, said bar having a pair of upwardly extending branches formed at sides of said central fulcrum;
a pair of H-shaped racks arranged symmetrically on said bar at sides of said central fulcrum, each of said racks having an inner post and an outer post, said inner post having a top guide wheel pivoted thereon;
a pair of carriages pivotally connected at inner sides thereof with said racks, respectively;
each of said carriages having a bottom track over corresponding one of said substantially horizontal tracks and an elastic member stretched substantially vertically between said bottom track and said corresponding one of said substantially horizontal tracks;
said carriages being provided with respective long, flexible linking members stretched between said carriages and said branches;
a pair of spaced rods extending upward from said stand and having respective top guide wheels pivoted thereon; and
said guide wheels on said rods, together with said guide wheels on said inner posts of said H-shaped racks, being capable of pressing said long, flexible linking members so as to control said carriages in such a way that said bottom tracks are always kept substantially horizontal when said bar is in any angular position relative to said stand;
wherein each of said carriages is equipped with an actuator for moving said elastic member to and fro along said tracks to change the perpendicular distance of the tension force of said elastic member from said central fulcrum and hence the moment of said tension force of said elastic member about said central fulcrum, thus swaying said bar and moving each of said carriages up and down between an highest position and a lowest position.

2. The power generating machine as claimed in claim 1, wherein said actuator is a motor.

3. The power generating machine as claimed in claim 1, wherein said long, flexible linking member is a cord.

4. The power generating machine as claimed in claim 1, wherein said long, flexible linking member is a chain.

5. The power generating machine as claimed in claim 1, wherein said elastic member is a spring.

6. The power generating machine as claimed in claim 1, wherein said carriages have respective outer sides opposed to said inner sides, and wherein said long, flexible linking members are stretched between said outer sides and said branches, and are pressed so as to control said carriages in such a way that said bottom tracks are kept substantially horizontal when said bar is in any angular position relative to said stand.

7. The power generating machine as claimed in claim 1, wherein said frame has a bottom crosspiece and a top crosspiece, and said crosspieces are formed with stems for stopping said carriages when said bar is sway to a certain angular position, thereby defining said highest position and said lowest position for each of said carriages.

8. The power generating machine as claimed in claim 7, wherein each of said stems ends in a damping spring.

9. The power generating machine as claimed in claim 1, wherein said guide wheels are arranged so that when either one of said carriages is moved to said highest position, one of said long, flexible linking members connected with said carriage in said highest position may be disengaged from at least one said guide wheel on corresponding one of said rods.

10. The power generating machine as claimed in claim 1, wherein said carriages have respective outer sides opposite to said inner sides, and each of said carriages is provided with a second elastic member stretched between said outer side thereof and said outer post of corresponding one of said H-shaped racks.
